(19) United States
(12) Patent Application Publication
(10) Pub. No.: US 2011/0243834 A1
(43) Pub. Date: Oct. 6, 2011

(54) Advanced Tritium System and Advanced Permeation System for Separation of Tritium from Radioactive Wastes and Reactor Water

(75) Inventor: Mark S. DENTON, Knoxville, TN (US)

(73) Assignee: KURION, INC., Oak Ridge, TN (US)

(21) Appl. No.: 13/079,331

(22) Filed: Apr. 4, 2011

Related U.S. Application Data
(60) Provisional application No. 61/320,515, filed on Apr. 2, 2010.

(51) Int. Cl. C01B 5/02; B01J 19/00

(52) U.S. Cl. 423/580.2; 422/162

(57) ABSTRACT

Systems, methods, and apparatuses for separating tritium from radioactive waste materials and the water from nuclear reactors. Some embodiments involve the reaction of tritiated hydrogen gases with water in the presence of a catalyst in a catalytic exchange column, yielding a more concentrated and purified tritiated water product. Some embodiments involve the use of a permeation module, similar in some respects to a gas chromatography column, in which a palladium permeation layer is used to separate tritiated hydrogen gas from a mixture of gases.

### CROSS-REFERENCE TO RELATED APPLICATIONS

This Application claims the benefit under 35 U.S.C. § 119(e) of U.S. Provisional Application 61/320,515, filed Apr. 2, 2010.

### STATEMENT REGARDING FEDERALLY-SPONSORED RESEARCH OR DEVELOPMENT

Not Applicable

### BACKGROUND OF THE INVENTION

1. Field of Invention

The present invention relates generally to the treatment of radioactive waste and in particular to the separation of tritium from radioactive waste materials.

2. Description of the Related Art

Tritium is a radioactive isotope of hydrogen with a half-life of approximately 12.3 years. As tritium is both a radioactive contaminant and a potentially useful material for numerous scientific and commercial applications, the generation of tritium in pressurized water reactors (PWRs) is a matter of vital interest. Normal reactor operations produce quantities of tritiated water. In particular, the use of boron as a moderator within reactor systems naturally leads to the production of tritium and to the presence of tritium-containing water molecules both within the water used for cooling the reactor and within water used in storage pools for radioactive waste materials.

Available public water treatment processes remove many radioactive contaminants but are ineffective for tritium. Tritium is one of several radioactive isotopes that, over time, concentrate in organic systems and enter the food chain, possibly with adverse environmental and public health effects. Tritium contamination of the groundwater in the vicinity of nuclear power stations, including PWRs, has led to public outcry and negative publicity for the nuclear power industry. Clearly, it would be advantageous to have methods, systems and apparatuses for the separation and concentration of tritium from light water used in PWRs and from water and liquids isolated from radioactive waste materials. (Herein, “light water” is used to refer to tritiated water, and especially HTO, and in opposition to “heavy water,” or D₂O, which is used in other nuclear applications.) The capability to separate tritium from reactor water and from radioactive waste materials is important for clean, safe, and secure radioactive waste management, which in turn is important for the safe and cost-effective use of nuclear power.

### BRIEF SUMMARY OF THE INVENTION

Disclosed herein are systems, methods, and apparatuses for separating tritium from radioactive waste materials and the water from nuclear reactors. Some embodiments of the present invention involve the reaction of tritiated hydrogen gases with water in the presence of a catalyst (often a palladium catalyst) in a catalytic exchange column, yielding a more concentrated and purified tritiated water product. Some embodiments involve the use of a permeation module, similar in some respects to a gas chromatography column, in which a palladium permeation layer is used to separate tritiated hydrogen gas from a mixture of gases.

In some of its various embodiments, the present invention includes an advanced tritium system (ATS) for the separation of tritium. An ATS receives water from a light water reactor or from radioactive waste treatment system. When it enters the ATS, the water contains tritium isotopes, primarily in the form of tritiated water (e.g. HTO), where at least one of the protonic hydrogen atoms of the water molecule has been replaced by a tritium atom. The water with tritiated water passes into an electrolyzer—generally an alkaline electrolyzer, although other electrolyzers are contemplated—where the tritiated water is broken up by electrolysis into a combination of oxygen gas (O₂) and hydrogen gas comprising a number of hydrogen isotopes and isotope combinations (e.g. H₂, HT, T₂). The oxygen gas is diverted and discharged from the ATS, while the hydrogen gas with tritium is directed to a gas purifier, where various contaminants entrained in the gas, such as KOH or another substance from the electrolyzer, are removed from the gas. The hydrogen gas passes from the gas purifier into a catalytic exchange column; in some embodiments, the hydrogen gas leaving the gas purifier first passes through a heater or a humidifier, or both, before entering the catalytic exchange column. Within the catalytic exchange column, tritium is separated from protonic hydrogen. Hydrogen gas, including gas molecules with tritium constituents, enters the bottom of the catalytic exchange column and rises through the height of the catalytic exchange column. Generally, the hydrogen gas with tritium has been heated before it enters the catalytic exchange column. Substantially simultaneously, purified (distilled or at least deionized) water from a purified water source is fed into the top of the catalytic exchange column and allowed to trickle down. The catalytic exchange column is packed with granulated palladium or a similar catalyst. When the rising hydrogen gas with tritium encounters the falling purified water in the presence of the catalyst within the catalytic exchange column, the hydrogen gas with tritium and the purified water react to yield tritiated water (e.g., HTO) and hydrogen gas that is substantially free of tritium isotopes (i.e., “detritiated hydrogen”). The detritiated hydrogen is vented from the catalytic exchange column, while the tritiated water exits the catalytic exchange column and proceeds to a holding tank. In many embodiments, the tritiated water in the holding tank is fed back into the electrolyzer in order to repeat the process of electrolysis and catalytic tritium separation, thereby yielding a tritiated water product with a higher concentration of tritium. Otherwise, the tritiated water proceeds from the holding tank to storage or other disposition. Passing tritiated water from a nuclear reactor, or from radioactive waste, through an ATS such as the one illustrated in FIG. 3 and outlined above results in a product of concentrated tritiated water. The ATS reduces the volume of water that includes tritium. In some embodiments of the present invention, tritiated water is passed through multiple catalytic exchange columns in series. Passing the tritiated water through multiple catalytic exchange columns more thoroughly separates protonic hydrogen from tritium and yields a purer, more concentrated final tritium product.

In some embodiments of the present invention, tritium is separated from protonic hydrogen through a combination of gas chromatography and hydrogen permeation through metal—a combination referred to collectively as the advanced permeation system (APS). In one embodiment of the APS, tritiated water enters an electrolyzer and is broken up by electrolysis into a combination of oxygen gas (O₂) and hydrogen gas comprising a number of hydrogen isotopes and isotope combinations (e.g. H₂, HT, T₂). The hydrogen gas then enters a cylindrical APS module. A carrier gas, such as helium or argon, is also inserted into the APS module along with the hydrogen gases. The gases under pressure enter a first end of the cylindrical APS module and travel along the length of the APS module. Within the APS module, the hydrogen gas and the carrier gas initially travel within the interior volume of an inner cylinder fabricated from a material that is at least semi-permeable to hydrogen. In some embodiments, the inner cylinder comprises two layers: a first layer of stainless steel frit, in direct contact with the interior volume of the inner cylinder; and a second layer of palladium. Surrounding the first layer and second layer of the inner cylinder and enclosed by the outer wall of the APS module is a separation volume. As the pressurized mixture of hydrogen gas and carrier gas enters the first end of the APS module and passes through the internal volume of the inner cylinder, pressure and elevated temperature drive hydrogen molecules to permeate the stainless steel frit and the palladium layer, so that hydrogen gases collect in the separation volume between the palladium layer and the outer wall. The carrier gas, not permeating the stainless steel frit and the palladium layer, passes through a second end of the APS module and is vented. Consistent with gas chromatography, lighter hydrogen molecules (H₂) permeate the stainless steel frit and the palladium layer closer to the first end of the cylindrical APS module; heavier hydrogen molecules (e.g., HT, T₂) permeate the stainless steel frit and the palladium layer closer to the second end of the cylindrical APS module. Lighter hydrogen gas (which is mostly H₂) within the separation volume is then released from the APS module. The heavier hydrogen gas, collected in the separation volume closer to the second end of the APS module, passes from the APS module to final disposition or further separation treatment. In some embodiments of the present invention, the hydrogen gas with a mixture of protonic hydrogen and heavier hydrogen isotopes is passed through several APS modules in series in order to enhance the separation of lighter protonic hydrogen from heavier hydrogen isotopes, including tritium. Passing the gas through each APS module further separates lighter hydrogen molecules from heavier hydrogen molecules and results in a purer, more concentrated final tritium product.

In some embodiments, the catalytic exchange column separation of tritium and APS-based separation of tritium are combined—generally run sequentially—to achieve a greater concentration and purity of final tritium product than achieved through either approach individually.

### BRIEF DESCRIPTION OF THE DRAWINGS

The above-mentioned and additional features of the invention will become more clearly understood from the following detailed description of the invention read together with the drawings in which:

FIG. 1 is a block diagram illustrating an example of a system for processing radioactive waste materials that includes an ATS for separating tritium from liquid radioactive waste material;

FIG. 2 is a block diagram illustrating an example embodiment of the present invention in which an ATS is used for separating tritium from the water used to cool a nuclear reactor;

FIG. 3 is a block diagram illustrating an example embodiment of an ATS according to the present invention, including a catalytic exchange column;

FIG. 4 is a block diagram illustrating an example embodiment of the present invention in which an ATS includes multiple catalytic exchange columns used in series;

FIG. 5 is a block diagram illustrating an example embodiment of the present invention in which an APS module is used for separating tritium from the hydrogen gas; and

FIG. 6 is a block diagram illustrating an example embodiment of the present invention in which multiple APS modules are used in series.

### DETAILED DESCRIPTION OF THE INVENTION

The present invention, in some of its embodiments, includes processes and methods for the separation, isolation, or removal (collectively “separation”) of tritium from radioactive waste.

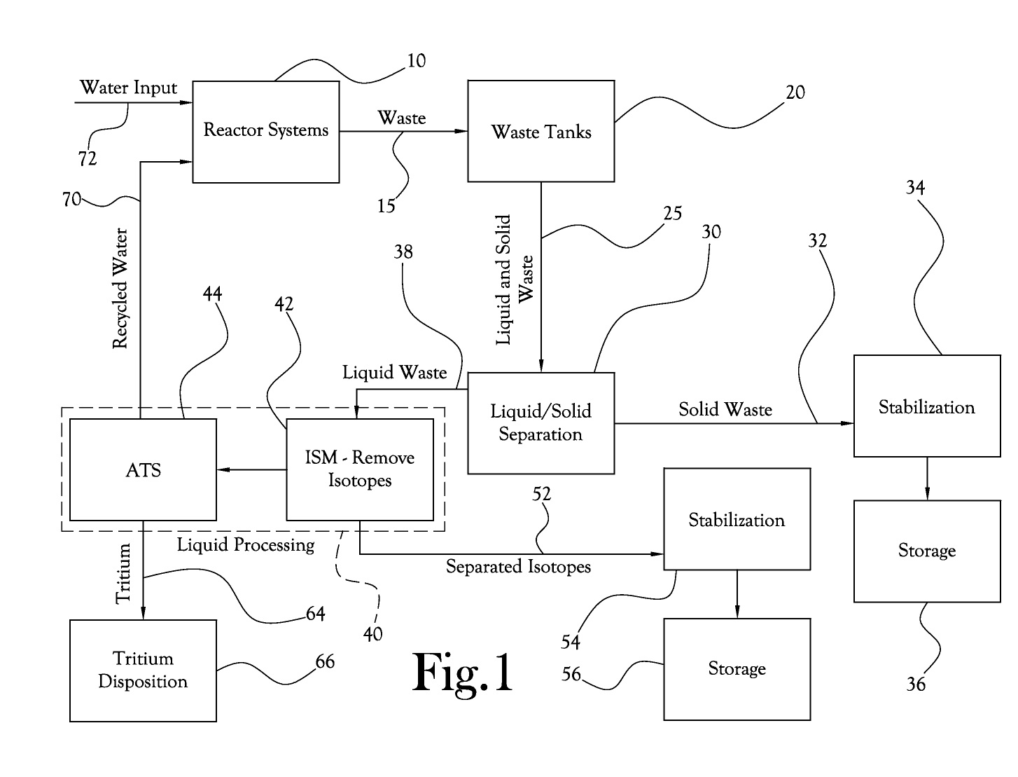

FIG. 1 illustrates an example embodiment of a larger system within which an advanced tritium system (ATS) for tritium separation is a component. As shown in the illustration, radioactive waste material from a nuclear reactor 10 is conveyed 15 first to waste tanks 20, where the waste material is kept submerged in water; as a result of storing radioactive waste, the water itself comes to contain a concentration of radioactive isotopes. The waste material, which at this stage includes both liquid and solid wastes, is conveyed 25 from the waste tanks 20 to a liquid/solid separation system 30 where liquid wastes (including the water from the waste tanks 20) are separated from the solid wastes. From the liquid/solid separation system 30, the solid wastes proceed 32 to stabilization 34 and storage 36. It is possible that, in some instances, not all of the moisture or liquid mixed with the solid wastes will be separated from the solid wastes by the liquid/solid separation system 30, in which case the stabilization and storage of those wastes will proceed differently.

From the liquid/solid separation system 30, liquid wastes that are substantially free of solid waste material proceed 38 to a liquid processing system 40. In some embodiments, such as the one illustrated in FIG. 1, the liquid processing system 40 comprises an isotope-specific-media-based system 42 for the separation of specific isotopes and an ATS 44 for the separation or removal of tritium from the liquid wastes. Separated isotopes 52 removed by isotope-specific media (ISM) from the liquid wastes are stabilized 54 and moved to storage 56 or other disposition (with the final disposition or storage conditions often dependent upon the specific isotope involved). Tritium removed from the liquid wastes proceeds 64 to its own disposition 66. The liquid (mostly water), now substantially free of specified radioactive isotopes and tritium, usually is recycled 70 into the reactor 10, where it is combined with other water 72 fed into the reactor 10. In some embodiments, liquid emerging from the liquid processing system 40 proceeds, not to the reactor 10 to be recycled, but to storage for low-classification waste.

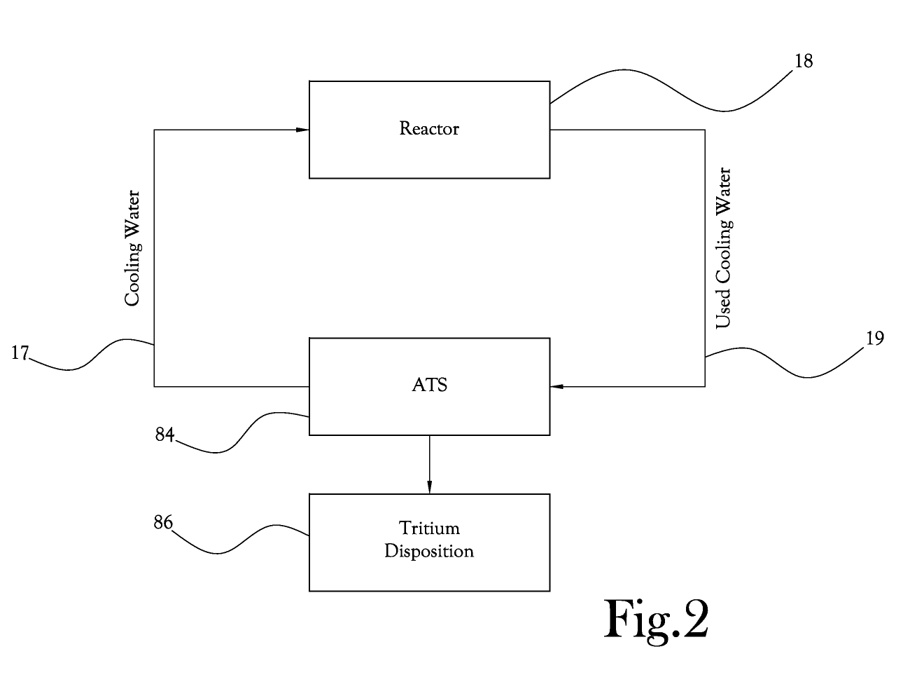

FIG. 2 illustrates another way in which an ATS according to the present invention is used with a nuclear reactor. In the illustrated embodiment, cooling water 17 supplied to the reactor 18 emerges 19 from the reactor 18 and is passed through an ATS 84 in order to remove tritium contaminants from the water. The separated tritium in diverted to disposal 86, either on-site or off-site, while the water, substantially freed of tritium contaminants, is recycled back into the reactor 18.

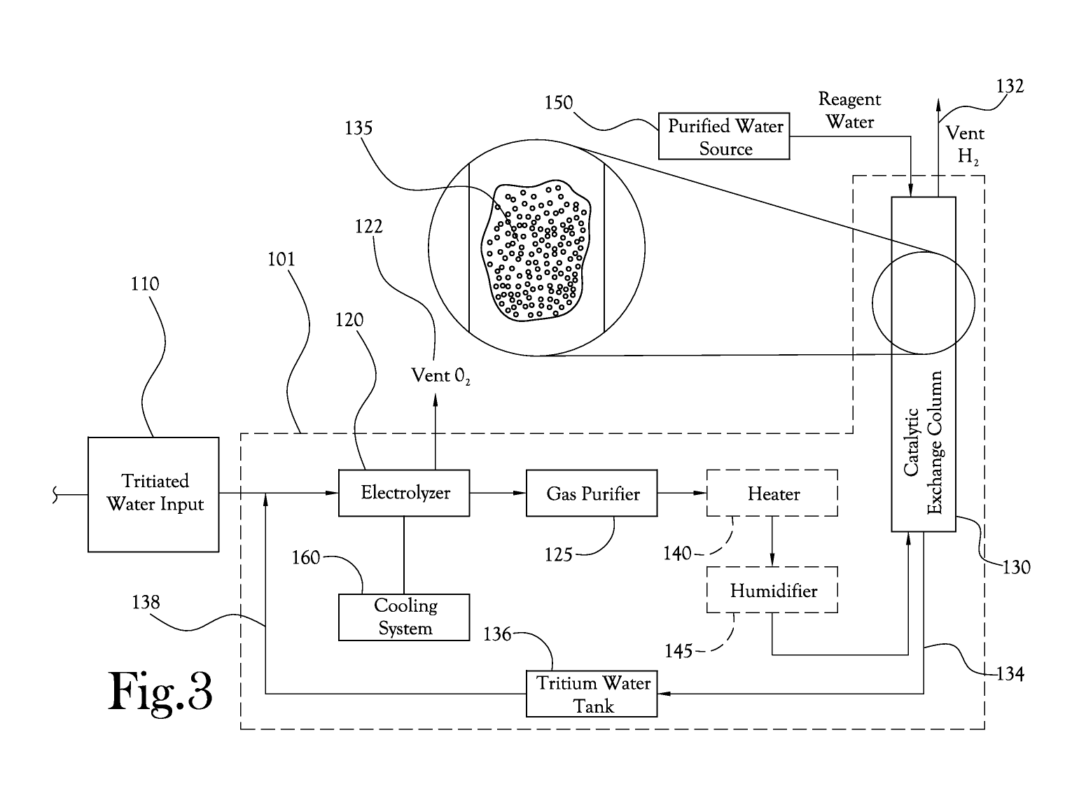

FIG. 3 illustrates a tritium separation system according to an example embodiment of the present invention. As shown in FIG. 3, in this embodiment, water enters the ATS 101 through an input 110; at this stage in the treatment of the water, the water contains tritium isotopes primarily in the form of tritiated water (e.g. HTO), where at least one of the protonic hydrogen atoms of the water molecule has been replaced by a tritium atom. The water with tritiated water passes into an electrolyzer 120—generally an alkaline electrolyzer, although other electrolyzers are contemplated—where the tritiated water is broken up by electrolysis into a combination of oxygen gas (O₂) and hydrogen gas comprising a number of hydrogen isotopes and isotope combinations (e.g. H₂, HT, T₂). The electrolysis of water generates heat, and therefore a cooling system 160 is connected to the electrolyzer 120 for maintaining the temperature of the electrolyzer 120 and other components of the ATS 101 within acceptable limits. The oxygen gas is diverted and discharged 122 from the ATS 101, while the hydrogen gas is directed to a gas purifier 125, where various contaminants entrained in the gas, such as KOH or another substance from the electrolyzer 120, are removed from the gas. The hydrogen gas passes from the gas purifier 125 into a catalytic exchange column 130; in some embodiments, the hydrogen gas leaving the gas purifier 125 first passes through a heater 140 or a humidifier 145, or both, before entering the catalytic exchange column 130. Within the catalytic exchange column 130, tritium is separated from protonic hydrogen. Hydrogen gas, including gas molecules with tritium constituents (i.e., tritiated hydrogen gas), enters the bottom of the catalytic exchange column 130 and rises through the height of the catalytic exchange column 130. Generally, the hydrogen gas with tritium has been heated before it enters the catalytic exchange column 130. Substantially simultaneously, purified water—distilled or at least deionized—from a purified water source 150 is fed into the top of the catalytic exchange column 130 and allowed to trickle down; this purified water is also called “reagent water” because it reacts with the hydrogen gas with tritium. The catalytic exchange column is packed with granulated palladium 135 or a similar catalyst (shown in the cutaway in the inset view in FIG. 3). When the rising hydrogen gas with tritium encounters the falling reagent water in the presence of the catalyst 135 within the catalytic exchange column 130, the hydrogen gas with tritium and the purified water react to yield tritiated water (e.g., HTO) and hydrogen gas that is substantially free of tritium isotopes (i.e., “detritiated hydrogen”). The detritiated hydrogen is vented 132 from the catalytic exchange column 130, while the tritiated water exits 134 the catalytic exchange column 130 and proceeds to a holding tank 136. In many embodiments, the tritiated water in the holding tank 136 is fed back 138 into the electrolyzer 120 in order to repeat the process of electrolysis and catalytic tritium separation, thereby yielding a tritiated water product with a higher concentration of tritium. Otherwise, the tritiated water proceeds from the holding tank 136 to storage or other disposition.

Passing tritiated water from a nuclear reactor, or from radioactive waste, through an ATS such as the example illustrated in FIG. 3 and outlined above results in a product of concentrated tritiated water. The ATS reduces the volume of water that includes tritium.

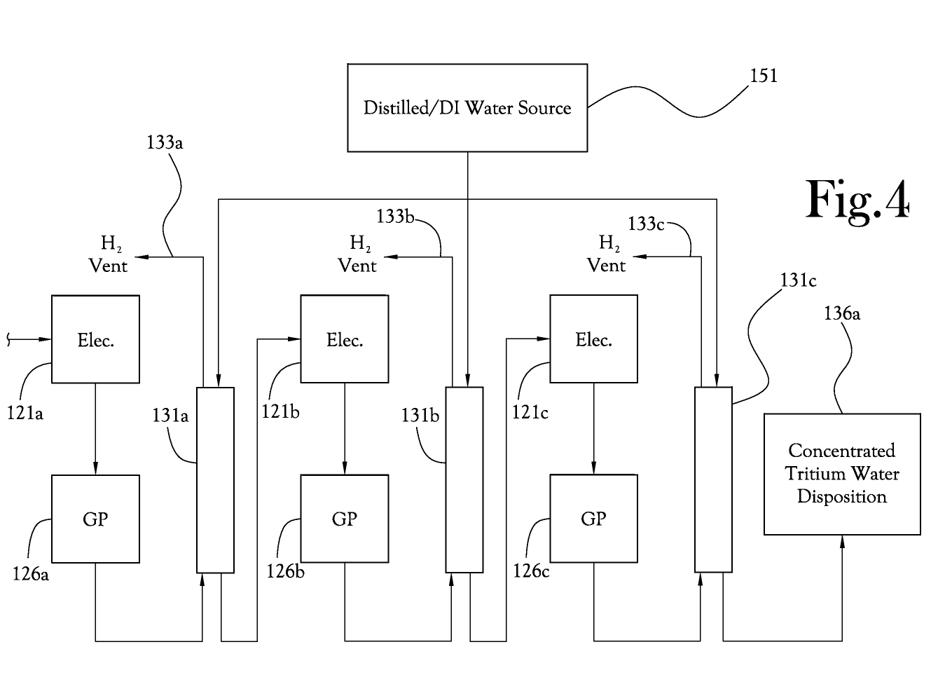

In some embodiments of the present invention, tritiated water is passed through multiple catalytic exchange columns in series. FIG. 4 illustrates one embodiment of the present invention in which tritiated water from a reactor or a waste source is passed through a first electrolyzer 121a, a first gas purifier 126a, and a first catalytic exchange column 131a; the output tritiated water from the first catalytic exchange column 131a is then passed through a second electrolyzer 121b, a second gas purifier 126b, and a second catalytic exchange column 131b; and the output tritiated water from the second catalytic exchange column 131b is then passed through a third electrolyzer 121c, a third gas purifier 126c, and a third catalytic exchange column 131c before proceeding to disposition 136a. Passing the tritiated water through multiple catalytic exchange columns more thoroughly separates protonic hydrogen from tritium and yields a purer, more concentrated final tritium product.

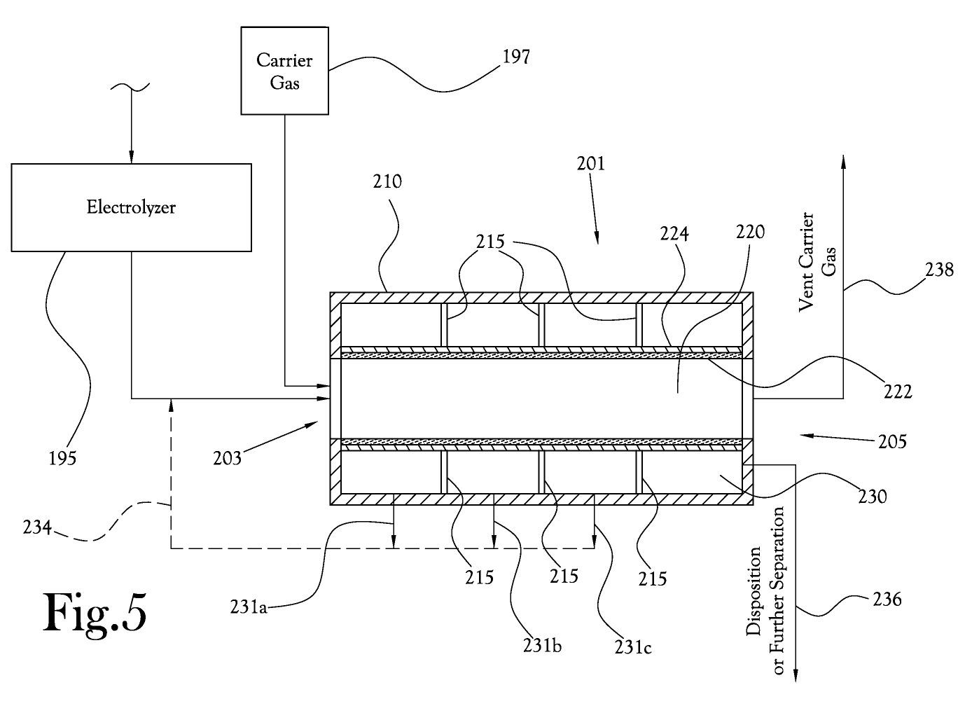

In some embodiments of the present invention, tritium is separated from protonic hydrogen through a combination of gas chromatography and hydrogen permeation through metal—a combination referred to collectively as the advanced permeation system (APS). In one embodiment of the APS, illustrated in FIG. 5, tritiated water enters an electrolyzer 195 and is broken up by electrolysis into a combination of oxygen gas (O₂) and hydrogen gas comprising a number of hydrogen isotopes and isotope combinations (e.g. H₂, HT, T₂). The hydrogen gas then enters the APS module 201, which in FIG. 4 is illustrated by a section view of a chromatography column or cylinder with an outer wall 210 fabricated from copper, stainless steel, or a similar material. A carrier gas 197, such as helium or argon, from a carrier gas source is also inserted into the APS module 201 along with the hydrogen gases. In many embodiments, the gases are pressurized as they enter the APS module 201. In some embodiments, the gases are heated as they enter the APS module 201.

In the illustrated example embodiment, the gases under pressure and slightly elevated temperature enter a first end 203 of the cylindrical APS module 201 and travel along the length of the APS module 201. Within the APS module 201, the hydrogen gas and the carrier gas initially travel within the interior volume 220 of at least one inner cylinder. The inner cylinder is fabricated from a material that is at least semi-permeable to hydrogen. In the illustrated embodiment of FIG. 5, the inner cylinder comprises two layers: a first layer 222 of stainless steel frit, in direct contact with the interior volume 220 of the inner cylinder; and a second layer 224 of palladium. In some embodiments, the stainless steel frit layer is omitted, and the palladium layer is in direct contact with the interior volume 220 of the inner cylinder. Surrounding the first layer 222 and second layer 224 of the inner cylinder and enclosed by the outer wall 210 of the APS module 201 is a separation volume 230.

As the pressurized mixture of hydrogen gas and carrier gas enters the first end 203 of the APS module 201 and passes through the internal volume 220 of the inner cylinder, pressure drives hydrogen molecules to permeate the stainless steel frit 222 and the palladium layer 224, so that hydrogen gases collect in the separation volume 230 between the palladium layer 224 and the outer wall 210. The carrier gas, not permeating the stainless steel frit 222 and the palladium layer 224, passes through a second end 205 of the APS module 201 and is vented 238. Consistent with gas chromatography, lighter hydrogen molecules (H₂) permeate the stainless steel frit 222 and the palladium layer 224 closer to the first end 203 of the cylindrical APS module 201; heavier hydrogen molecules (e.g., HT, T₂) permeate the stainless steel frit 222 and the palladium layer 224 closer to the second end 205 of the cylindrical APS module 201. In some embodiments, the APS module 201 includes partitions 215 that divide the separation volume 230 into distinct compartments; the compartments closer to the first end 203 of the APS module 201 for receiving lighter hydrogen molecules, and the compartments closer to the second end 205 of the APS module 201 for receiving the heavier hydrogen molecules, including molecules with tritium atoms. Lighter hydrogen gas (which is mostly H₂) within the separation volume 230 is then released 231a-c from the APS module 201; in some embodiments, the lighter hydrogen gas is recycled 234 through the APS module in order to separate remaining trace amounts of tritium within the gas; in other embodiments, the lighter hydrogen gas is vented to the atmosphere. The heavier hydrogen gas, collected in the separation volume 230 closer to the second end 205 of the APS module 201, passes from the APS module 201 to final disposition or further separation treatment 236.

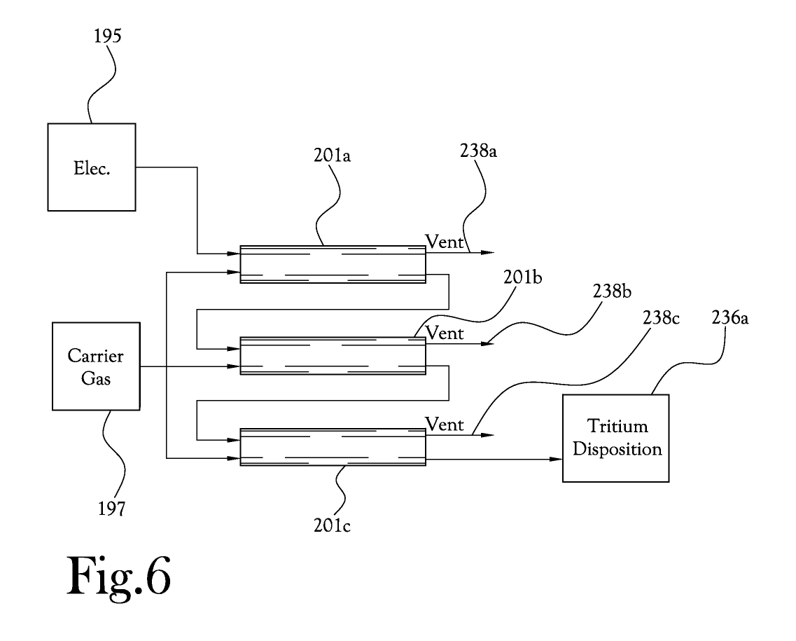

In some embodiments of the present invention, the hydrogen gas with a mixture of protonic hydrogen and heavier hydrogen isotopes is passed through several APS modules in series in order to enhance the separation of lighter protonic hydrogen from heavier hydrogen isotopes, including tritium. FIG. 6 illustrates one system for passing hydrogen gas through several APS modules in series. Hydrogen gas with a mixture of protonic hydrogen and heavier hydrogen isotopes emerges from an electrolyzer 195 and mixes with carrier gas 197 to pass through a first APS module 201a; within the APS module 201a, the hydrogen gases permeate the stainless steel frit and the palladium layer, and the gas containing heavier hydrogen molecules (e.g., HT, T₂) is separated from lighter hydrogen gas (H₂), as described above. The gas containing heavier hydrogen molecules is then directed 235a through a second APS module 201b, where further separation takes place; and then the gas containing heavier hydrogen molecules is directed 235b through a third APS module 201c before passing to final disposition 236a. Passing the gas through each APS module further separates lighter hydrogen molecules from heavier hydrogen molecules and results in a purer, more concentrated final tritium product.

In some embodiments, the catalytic exchange column separation of tritium and APS-based separation of tritium are combined—generally run sequentially—to achieve a greater concentration and purity of final tritium product than achieved through either approach individually.

The present invention is not limited to the illustrated embodiments. In some alternative embodiments, a catalyst other than palladium is used in the catalytic exchange column. In some embodiments, the catalytic exchange column is a liquid phase catalytic exchange column.

While the present invention has been illustrated by description of some embodiments, and while the illustrative embodiments have been described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A method to separate tritiated water from protiated water, comprising:
passing water containing tritiated water and protiated water through an electrolyzer to generate protonic hydrogen gas and tritiated hydrogen gas;
introducing the protonic hydrogen gas and tritiated hydrogen gas to the bottom of a catalytic exchange column such that the protonic hydrogen gas and tritiated hydrogen gas rise through the catalytic exchange column;
introducing reagent water into the catalytic exchange column such that the reagent water trickles down the catalytic exchange column, the catalytic exchange column being filled with a catalyst to facilitate a reaction between the reagent water and the tritiated hydrogen gas, such that tritiated hydrogen gas reacts with the reagent water to form tritiated water;
venting protonic hydrogen gas from the catalytic exchange column; and
collecting tritiated water from the catalytic exchange column.

2. The method of claim 1 wherein said catalyst in the catalytic exchange column comprises palladium.

3. The method of claim 1 wherein the catalytic exchange column is a liquid phase catalytic exchange column.

4. The method of claim 1 further comprising:
before introducing the protonic hydrogen gas and tritiated hydrogen gas to the bottom of a catalytic exchange column, passing the protonic hydrogen gas and tritiated hydrogen gas through a gas purifier to remove entrained contaminants in the protonic hydrogen gas and tritiated hydrogen gas.

5. The method of claim 1 further comprising:
passing the protonic hydrogen gas and tritiated hydrogen gas through a heater to heat the gas before introducing the protonic hydrogen gas and tritiated hydrogen gas to the bottom of the catalytic exchange column.

6. The method of claim 1 further comprising:
passing the protonic hydrogen gas and tritiated hydrogen gas through a humidifier before introducing the protonic hydrogen gas and tritiated hydrogen gas to the bottom of the catalytic exchange column.

7. An apparatus to separate tritiated water from protiated water, comprising:
an electrolyzer to receive water containing tritiated water and protiated water and to generate protonic hydrogen gas and tritiated hydrogen gas;
a gas purifier to remove entrained contaminants in the protonic hydrogen gas and tritiated hydrogen gas;
a catalytic exchange column to receive protonic hydrogen gas, tritiated hydrogen gas, and reagent water, the catalytic exchange column being filled with a catalyst to facilitate a reaction between reagent water and the tritiated hydrogen gas, such that tritiated hydrogen gas reacts with reagent water to form tritiated water; and
a holding tank to receive tritiated water from the catalytic exchange column.

8. The apparatus of claim 7 wherein the catalyst in the catalytic exchange column comprises palladium.

9. The apparatus of claim 7 wherein the catalytic exchange column is a liquid phase catalytic exchange column.

10. The apparatus of claim 7 further comprising:
before introducing the protonic hydrogen gas and tritiated hydrogen gas to the bottom of a catalytic exchange column, passing the protonic hydrogen gas and tritiated hydrogen gas through a gas purifier to remove entrained contaminants in the protonic hydrogen gas and tritiated hydrogen gas.

11. The apparatus of claim 7 further comprising a heater to heat the gas before introducing the protonic hydrogen gas and tritiated hydrogen gas to the catalytic exchange column.

12. The apparatus of claim 7 further comprising a humidifier to wet the protonic hydrogen gas and tritiated hydrogen gas before introducing the protonic hydrogen gas and tritiated hydrogen gas to the catalytic exchange column.

13. The apparatus of claim 7 further comprising a permeation system to separate tritiated hydrogen gas from hydrogen gas exiting the catalytic exchange column, said permeation system comprising:
a module to receive hydrogen gas that includes protonic hydrogen gas and tritiated hydrogen gas, said module including two interior volumes, including a first volume to receive protonic hydrogen gas and tritiated hydrogen gas, and a second volume to receive separated tritiated hydrogen gas; and
a palladium layer separating the first volume from the second volume, said palladium layer being permeable to tritiated hydrogen gas.

14. A system to separate tritiated hydrogen gas from mixed protonic and tritiated hydrogen gas, comprising:
an electrolyzer to generate protonic hydrogen gas and tritiated hydrogen gas;
a carrier gas source to supply a carrier gas;
a cylinder to receive at one end, under pressure, protonic hydrogen gas, tritiated hydrogen gas, and carrier gas, said cylinder being surrounded by a layer of palladium that is at least semi-permeable to hydrogen gas; and
a module surrounding said cylinder and said layer of palladium, said module encompassing a volume to receive tritiated hydrogen gas,
whereby when protonic hydrogen gas, tritiated hydrogen gas, and carrier gas are introduced under pressure to said one end of the cylinder, the protonic hydrogen gas permeates one part of the palladium layer surrounding the cylinder and the tritiated hydrogen gas permeates a second part of the palladium layer surrounding the cylinder, tritiated hydrogen gas proceeding from the second part of the palladium layer into the volume to receive tritiated hydrogen gas.

15. The system of claim 14 wherein the system includes multiple cylinders and modules, hydrogen gas from the elctrolyzer passing through each cylinder and module in series.
